(19) United States
(12) Patent Application Publication
(10) Pub. No.: US 2026/0194176 A1
(43) Pub. Date: Jul. 9, 2026

(54) DIRECTIONAL MOUNTING DEVICE AND METHODS OF USE

(71) Applicant: LiveView Technologies, LLC, American Fork, UT (US)

(72) Inventors: Jordan SMITH, Spanish Fork, UT (US); Michael J. GLEASON, Orem, UT (US)

(21) Appl. No.: 19/201,699

(22) Filed: May 7, 2025

Related U.S. Application Data
(60) Provisional application No. 63/741,583, filed on Jan. 3, 2025.

(51) Int. Cl. F16M 11/04; F21V 17/06; F21V 17/10

(52) U.S. Cl. CPC F16M 11/04; F21V 17/06; F21V 17/10; F16M 2200/028

(57) ABSTRACT

A device may include a mount body including: a flange protruding radially outward in a first plane, and a pin pocket recessed into the mount body normal to the first plane. A device may include a base surface. A device may include a collar coupled to the base surface including: a slot arranged in a second plane and configured to receive the flange, and a locking pin movable in a locking direction normal to the second plane and configured to insert into the pin pocket.

### CROSS-REFERENCE TO RELATED APPLICATIONS

This application claims priority to and the benefit of U.S. Provisional Patent Application No. 63/741,583, filed on Jan. 3, 2025, which is hereby incorporated by reference in its entirety.

### TECHNICAL FIELD

This disclosure relates generally to directional mounting devices for mounting electronic components on a frame.

### BACKGROUND

Remote surveillance systems include a power supply, a computing device, and one or more sensors in a self-contained unit. An operator or technician may deploy the unit in a remote location without an existing infrastructure, such as external electrical sources or hard-wired communication systems.

### BRIEF SUMMARY

In some aspects, the techniques described herein relate to a mounting device including: a mount body including: a flange protruding radially outward in a first plane, and a pin pocket recessed into the mount body normal to the first plane; a base surface; and a collar coupled to the base surface including: a slot arranged in a second plane and configured to receive the flange, and a locking pin movable in a locking direction normal to the second plane and configured to insert into the pin pocket.

In some aspects, the techniques described herein relate to a system for mounting an electronic component, the system including: a frame configured to support at least one electronic component; a mast connection coupled to a bottom side of the frame; and a mounting device coupled to a top side of the frame, the mounting device including: a mount body including: a flange protruding radially outward in a first plane, and a pin pocket recessed into the mount body normal to the first plane, a base surface coupled to the frame, and a collar coupled to the base surface including: a slot arranged in a second plane and configured to receive the flange; and a locking pin movable in a locking direction normal to the second plane and configured to insert into the pin pocket.

In some aspects, the techniques described herein relate to a method of mounting an electronic component on a frame, the method including: inserting a tapered end of a flange of a mount body in a collar; contacting an end of a locking pin with a ramp surface of the mount body; translating the mount body and ramp surface relative to the collar and the locking pin in a first direction; moving the locking pin in a second direction perpendicular to the first direction based on contact with the ramp surface; aligning a pin pocket of the mount body and the locking pin; and moving the locking pin into the pin pocket.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a perspective view of an embodiment of a unit, in accordance with various embodiments of the disclosure.

FIG. 2 is a detail view of an embodiment of a head unit, in accordance with various embodiments of the disclosure.

FIG. 3 is a detail view of an embodiment of a head unit during assembly of the head unit, in accordance with various embodiments of the disclosure.

FIG. 4 is a perspective view of a mounting device, in accordance with various embodiments of the disclosure.

FIG. 5 is a cross-sectional detail view of an embodiment of a trailing edge of a mount body, in accordance with various embodiments of the disclosure.

FIGS. 6-1 through 6-3 illustrate an embodiment of assembling a mounting device, in accordance with various embodiments of the disclosure.

FIG. 7 is a bottom view of an embodiment of a mount body illustrating a ramp surface and pin pocket, in accordance with various embodiments of the disclosure.

FIG. 8 is a flowchart illustrating a method of use of a mounting device, according to some embodiments of the present disclosure.

### DETAILED DESCRIPTION

A mounting system according to the present disclosure allows the connection of an electronic component to a frame of a mobile unit (e.g., a mobile security unit). More particularly, a mounting device according to the present disclosure provides visual, audible, and/or tactile confirmation of alignment and connection of a component to a frame for assembly in adverse conditions and/or locations. An operator and/or technician may attach one or more components of the unit in a deployment location, as the one or more components may be packaged separately for storage and/or transit to protect the components while the frame of the unit is trailered or moved to the deployment location. In some examples, the unit includes a mast to elevate one or more sensors, one or more output devices, and/or communication antennae for greater visibility and/or less interference with surrounding environmental objects. In some examples, the unit is deployed in a remote location and/or in adverse conditions (poorly lit location, adverse weather, etc.) that further limit the operator's ability to see and confirm the proper connection and/or orientation of the component on the head unit. One or more embodiments of a mounting device of the present disclosure allows an operator to align, connect, and secure an electronic component to a head unit even while doing so with limited ability to see the actual mounting device.

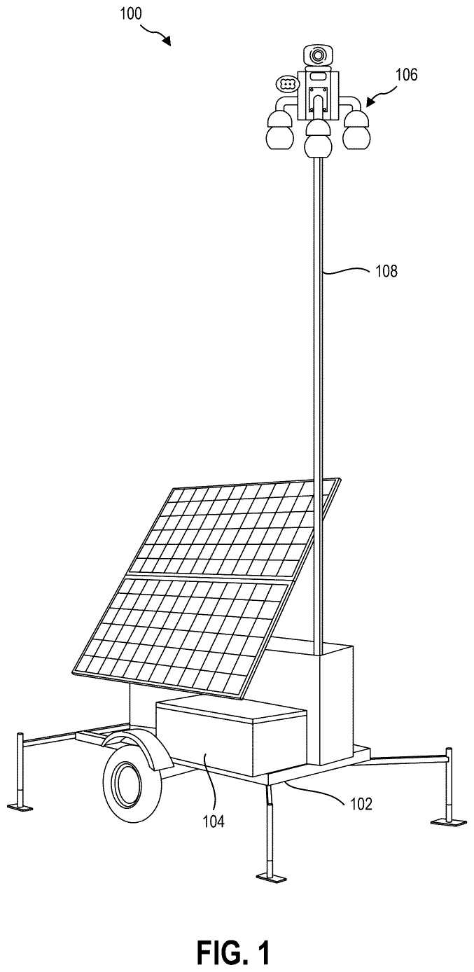

FIG. 1 is a perspective view of an embodiment of a unit 100, in accordance with various embodiments of the disclosure. Unit 100, which may also be referred to herein as a “mobile unit,” a “mobile security unit,” a “live unit,” or a “physical unit,” may be configured to be positioned in an environment (e.g., a parking lot, a roadside location, a construction zone, a concert venue, a sporting venue, a school campus, without limitation). In some embodiments, unit 100 may include one or more sensors (e.g., cameras, weather sensors, motion sensors, noise sensors, without limitation) and one or more output devices (e.g., lights, speakers, electronic displays, without limitation). Unit 100 may also include at least one storage device (e.g., internal flash media, a network attached storage device, or any other suitable electronic storage device), which may be configured for receiving and storing data (e.g., video, images, audio, without limitation) captured by one or more sensors of unit 100.

In some embodiments, unit 100 may include a mobile security unit (also referred to as a “mobile surveillance unit” or an “MSU”). In these and other embodiments, unit 100 may include a portable trailer 102, a storage box 104, and a mast 108 coupled to a head unit 106 which may include, for example, one or more batteries, one or more cameras, one or more lights, one or more speakers, and/or one or more microphones. According to some embodiments, a first end of mast 108 may be proximate to storage box 104 and a second, opposite end of mast 108 may be proximate, and possibly adjacent, to head unit 106. More specifically, in some embodiments, head unit 106 may be coupled to mast 108 at an end opposite to an end of mast 108 proximate to storage box 104.

In some examples, unit 100 may include one or more primary batteries (e.g., within storage box 104) and one or more secondary batteries (e.g., within head unit 106). In these embodiments, a primary battery positioned in storage box 104 may be coupled to a load and/or a secondary battery positioned within head unit 106 via, for example, a cord reel.

In some embodiments, unit 100 may also include one or more power sources and/or power supplies. For example, the unit 100 may include or be in electrical communication with one or more solar panels, which may provide power to one or more batteries of unit 100. More specifically, according to some embodiments, one or more solar panels may provide power to a primary battery within storage box 104. In some embodiments, the unit 100 may also include other power sources, such as one or more generators (e.g., fuel cell generator, fossil fuel generator), wind turbines, etc.

During transport or storage of the unit 100, one or more components of the unit 100 may be removed from the unit 100, the mast 108, or the head unit 106. In some embodiments, the mast 108 is an extendable or deployable mast and the mast 108 is extended or deployed at the time of deployment of the unit 100 in a field location. For example, the mast 108 may be connected to the trailer 102 and/or storage box 104 at a first end of the mast 108, and the head unit 106 may be positioned at an elevated position at the second end of the mast 108 upon deployment of the unit 100. In some embodiments, the head unit 106 includes one or more sensors (e.g., cameras, weather sensors, motion sensors, noise sensors, without limitation) and one or more output devices (e.g., lights, speakers, electronic displays, without limitation) that are affixed to the head unit 106 upon deployment. In some embodiments, the head unit 106 is positioned on the second end of the mast 108 prior to an electronic component (such as one or more sensors and/or one or more output devices) being connected thereto. In particular examples, the unit 100 is deployed in a remote location, a poorly lit location, or at a location with limited assembly resources (such as ladders or other platforms from which a technician can work). As such, electronic components of the head unit may, in some examples, be connected to the head unit 106 with limited or compromised visibility to the mount connecting the electronic component to a frame of the head unit 106. A mount that provides reliable and secure connection and orientation of the electronic components to the head unit 106 can save time and resources by allowing more rapid and more reliable deployment with fewer corrective measures required.

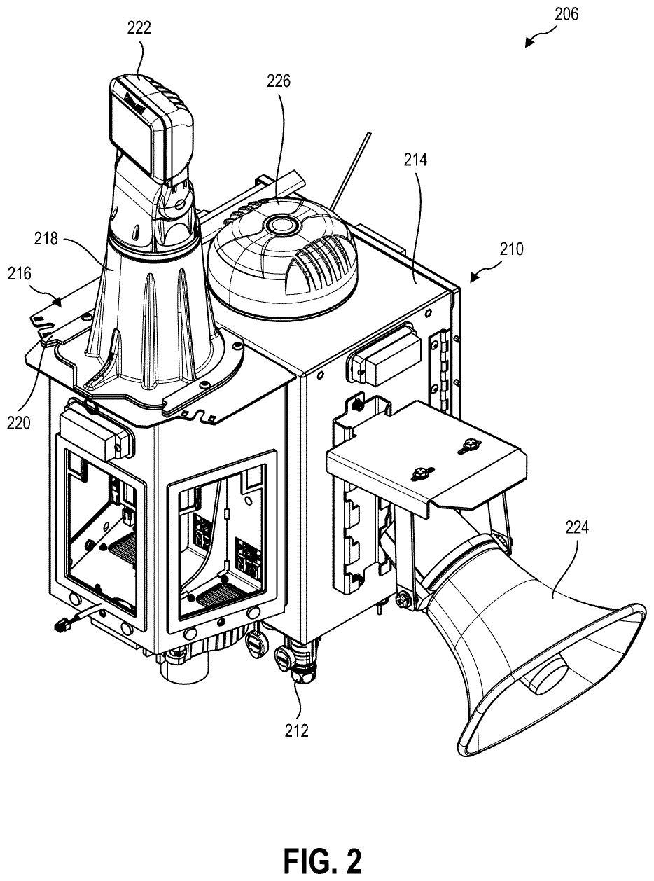

FIG. 2 is a detail view of an embodiment of a head unit 206 according to the present disclosure. As described herein, in some embodiments, the head unit 206 includes a plurality of electronic components mounted thereto and supported by a frame 210. The frame 210 is coupled to and/or connected to a mast connection 212. The mast connection 212 is configured to connect the head unit 206 to a mast, such as the mast 108 described in relation to FIG. 1. In some embodiments, the mast connection 212 allows the frame 210 to be selectively connected to the mast. For example, the mast connection 212 may include a cam lock mechanism to compressively connect the mast connection 212 to the mast. In some examples, the mast connection 212 includes a threaded connection. In some examples, the mast connection includes a twist lock connection. In some embodiments, the mast connection 212 is configured to permanently affix the head unit 206 to the mast. For example, the mast connection 212 may be a recess, a slot, a cylinder, a post, or other structure of the frame 210 to which the mast may be welded or otherwise permanently affixed.

In some embodiments, the head unit 206 is connected to the mast by a mast connection 212 on a bottom side of the head unit 206, and a top surface 214 of the frame 210 (opposite the mast connection 212) is oriented away from the mast, the storage box, the trailer, and/or the ground upon which the unit 100 is being deployed. The top surface 214 may be relatively inaccessible by a technician or other individual deploying the unit, therefore. In such embodiments, a mounting device 216 located on the top surface 214 is assembled during deployment with limited or no ability to visually confirm a connection of the mounting device 216.

In some embodiments, the mounting device 216 according to the present disclosure includes a mount body 218 and a collar 220. In some embodiments, the collar 220 is coupled to the frame 210 of the head unit 206. In some examples, the collar 220 is coupled to the top surface 214 of the frame 210 of the head unit 206. In some examples, the collar 220 is coupled to the frame 210 on a side opposite the mast connection 212. In some embodiments, the collar 220 includes a single, monolithic element (e.g., cast or machined material) that is coupled to the frame 210. In some embodiments, the collar 220 is integrally formed with at least a portion of the frame 210 and/or includes an integral member coupled to the frame 210. For example, an integrally formed collar 220 is machined or cast directly from a component of the frame 210 such that the material of the collar is substantially continuous with that of the component of the frame 210.

In some embodiments, the mount body 218 couples to the collar 220. For example, the collar 220 receives at least a portion of the mount body 218 to fix the mount body 218 relative to the collar 220. In some examples, the mount body 218 and collar 220 interact during insertion of the mount body 218 into the collar 220 to orient the mount body 218 to the collar 220. In some embodiments, the mount body 218 supports a directional electronic component of the head unit 206. A directional electronic component is any electronic component of the head unit 206 and/or the unit 100 to which it is mounted for which the relative direction of the directional electronic component matters to the operation of the head unit 206 and/or unit 100. For example, a spotlight 222 is a directional electronic component. In some examples, the spotlight 222 includes a pan motor and/or tilt motor to adjust a direction of the light produced by the spotlight 222. For a software control or remote operator control of the spotlight 222, the relative direction of the mount body 218 to the head unit 206 may be important for control and/or operation of the spotlight 222. In some examples, a directional electronic component may include a camera (video or still), a directional microphone, a directional loudspeaker 224, an infrared illumination source, a ranging device (such as a time-of-flight camera), etc. In some embodiments, the head unit 206 further includes non-directional or omni-directional electronic components. For example, a non-directional or omni-directional electronic component may be a motion sensor 226 that detects motion in a 360° range around the head unit 206 or a light (status or area illumination) that emits light in substantially all directions.

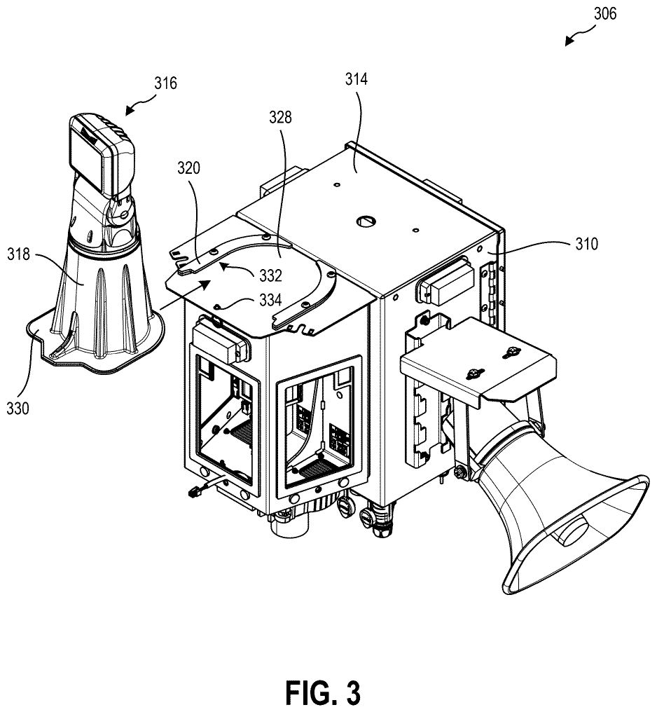

FIG. 3 is a detail view of an embodiment of a head unit 306 during and/or prior to assembly of at least a portion of the head unit 306. In some embodiments, electronic components of the head unit 306 are connected to the head unit 306 during deployment in the field. The mounting device 316 couples the mount body 318 to the frame 310 of the head unit 306. In some embodiments, the collar 320 is coupled to and/or integrally formed with a base surface 328. In some embodiments, the base surface is a top surface 314 of the frame 310. The mount body 318 includes a flange 330 that protrudes radially outward from the mount body 318 and is substantially flat in a first plane. In some embodiments, the flange 330 has a constant thickness throughout the flange 330. In some embodiments, the flange 330 has a thickness that tapers in at least one direction. For example, the flange 330 may have a thickness that tapers towards the transverse sides (e.g., transverse to an insertion direction into the collar 320) to help center the mount body 318 in the collar 320. In another example, the flange 330 may have a thickness that tapers towards the collar (e.g., in an insertion direction into the collar 320) to help compress the flange 330 under the collar 320 and align the mount body 318 to the base surface 328 of the collar 320. In some embodiments, the collar 320 defines a slot 332 in a second plane between a top of the collar 320 and the base surface 328. The slot 332 is configured to receive at least a portion of the flange 330 between the collar 320 and the base surface 328. The second plane may be substantially parallel to the first plane.

In some embodiments, the collar 320 and base surface 328 limit the translational movement of the mount body 318 (e.g., sliding) relative to the collar 320 when the flange 330 and slot 332 are misaligned. For example, the collar 320 and/or slot 332 and flange 330 may be complementarily shaped and asymmetrical front-to-back. Such asymmetry ensures the mount body 318 cannot be inserted into the collar 320 misaligned, enforcing the orientation of the mount body 318 and any directional electronic components coupled thereto. In some embodiments, such limitation on the insertion of the flange 330 can provide tactile, visual, or audible feedback that the mount body 318 and collar 320 are not aligned correctly.

In some embodiments, the mounting device 316 further includes a locking pin 334 movable in a locking direction normal to the second plane. In some embodiments, the locking pin 334 is biased (e.g., spring-loaded) to move in the locking direction normal to the second plane and/or the base surface 328. The locking pin 334 interacts with a portion of the mount body 318 to retain the mount body 318 in an inserted position when inserted into and properly aligned with the collar 320. In some embodiments, the locking pin 334 is displaced away from an original position downward and/or away from the mount body 318 during insertion of the mount body 318 into the collar 320. In some embodiments, the locking pin 334 moves in the locking direction upon complete insertion and alignment of the mount body 318 relative to the collar 320. For example, a biasing element of the locking pin 334 may apply a restoring force to the locking pin when displaced away from the mount body 318 during insertion, and the biasing element restores the locking pin 334 to or toward the original position upon complete insertion and alignment of the mount body 318 relative to the collar 320. In some embodiments, when the mount body 318 is inserted into the collar 320 in an intended position (e.g., when the mount body 318 is completely inserted and aligned relative to the collar 320), the biasing element restores the locking pin 334 toward the original position and may be received in an aperture of the flange 330 to lock the mounting device 316 in position.

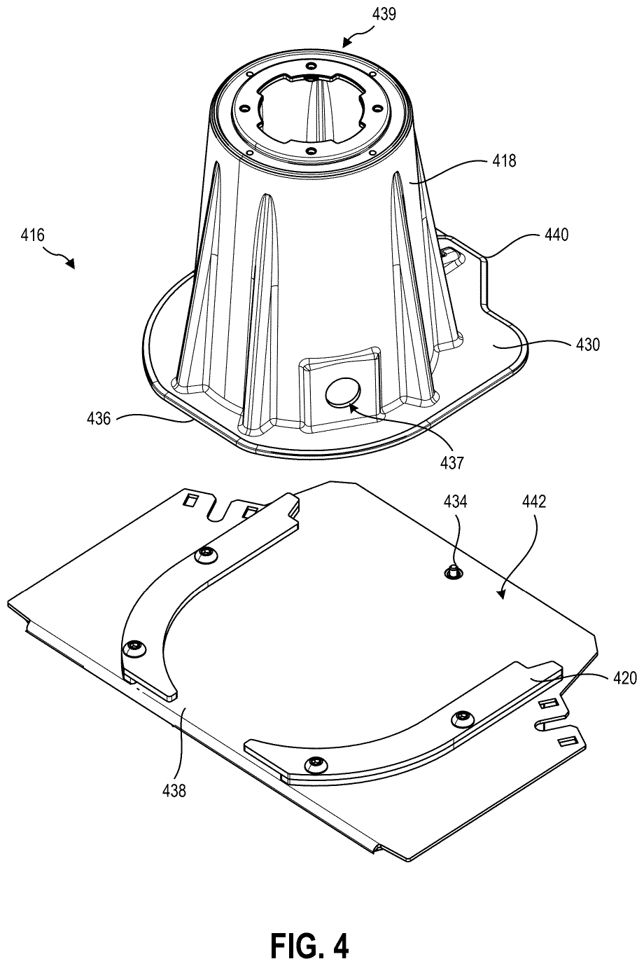

FIG. 4 is a perspective view of a mounting device 416 according to some embodiments of the present disclosure. The mounting device 416 includes a mount body 418 and a collar 420. The mount body 418 includes a flange 430 with a leading edge 436 and a trailing edge 440, where the leading edge 436 is configured to be inserted into the collar 420 to orient the mount body 418 relative to the collar 420. In some embodiments, the flange 430 is asymmetric front-to-back (e.g., the leading edge 436 has a different shape than the trailing edge 440). In some embodiments, the flange 430 tapers toward the leading edge 436. For example, the leading edge 436 may taper to a round end. In some examples, the leading edge 436 tapers to a point. In some embodiments, the tapered leading edge 436 is narrower than the trailing edge 440. In some embodiments, the tapered leading edge 436 applies a torque to the mount body 418 when inserted into the collar 420 to rotate the mount body 418 into alignment with (and a known orientation relative to) the collar 420.

In some embodiments, the collar 420 has a distal end 438 and a proximal end 442, where the flange 430 is inserted into the collar 420 at the proximal end 442. During installation, the technician or operator then pushes the mount body 418 into the collar 420 toward the distal end 438. As the mount body 418 and the flange 430 move into the collar 420, a ramp surface (not visible in FIG. 4) of the mount body 418 interacts with the locking pin 434. The ramp surface moves the locking pin away from the flange 430 until the locking pin 434 aligns with a pin pocket of the trailing edge 440 and enters the pin pocket, as described in relation to FIGS. 6-1 through 6-3 below.

In some embodiments, the mount body 418 includes a mount surface 439 upon which an electronic component may be coupled to the mount body 418 and supported thereby on the head unit. In some embodiments, the mount body 418 includes a lateral port 437 in a lateral surface of the mount body 418 between the flange 430 and the mount surface 439. In some embodiments, the lateral port 437 allows a cable, wire, or other conduit for electrical communication between the electronic component and a computing device or other controller of the electronic component in the head unit and/or unit. In at least one embodiment, the computing device is located in a storage box or other portion of the unit, and the cable, wire, or other conduit for electrical communication is routed through the mast to the computing device.

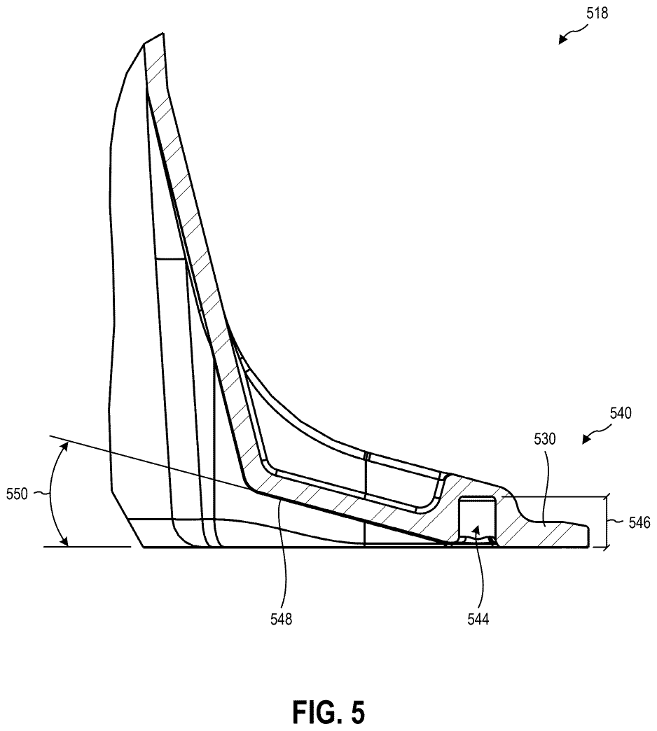

FIG. 5 is a cross-sectional detail view of an embodiment of a trailing edge 540 (e.g., trailing edge 440 of FIG. 4) of the mount body 518. In some embodiments, the flange 530 proximate to the trailing edge 540 includes a pin pocket 544. For example, the embodiments of a pin pocket 544 described in relation to FIG. 5 may be applied to the embodiments of the mounting devices described in relation to FIGS. 2 through 4. In some embodiments, the pin pocket 544 has a pin depth 546 sufficient to allow the locking pin (such as the locking pin 334, 434 described in relation to FIG. 3 and FIG. 4) to engage with the pin pocket 544 and limit and/or prevent movement of the mount body 518 relative to the collar. In some embodiments, the locking pin includes a biasing element that urges the locking pin into the pin pocket 544 and holds the locking pin in the pin pocket 544. To depress the locking pin prior to the pin pocket 544, the mount body 518 includes a ramp surface 548 that contacts the locking pin and urges the locking pin away from (e.g., downward) the flange 530 as the mount body 518 moves relative to the collar and locking pin.

In some embodiments, the ramp surface 548 is oriented at a ramp angle 550 relative to the first plane of the flange 530 (i.e., the plane defined by the bottom of the mount body 518). In some embodiments, the ramp surface 548 is substantially linear. In some embodiments, the ramp surface 548 is curved. In some embodiments, at least a portion of the ramp surface 548 is linear and at least a portion of the ramp surface 548 is curved. At least a portion of the ramp surface 548 is oriented at a ramp angle 550 in a range having an upper value, a lower value, or upper and lower values including any of 1°, 5°, 10°, 15°, 20°, 25°, 30°, or any values therebetween. In some examples, the at least a portion of the ramp surface 548 is at a ramp angle 550 greater than 1°. In some examples, the at least a portion of the ramp surface 548 is at a ramp angle 550 less than 30°. In some examples, the at least a portion of the ramp surface 548 is at a ramp angle 550 between 1° and 30°. In some examples, the at least a portion of the ramp surface 548 is at a ramp angle 550 between 5° and 20°.

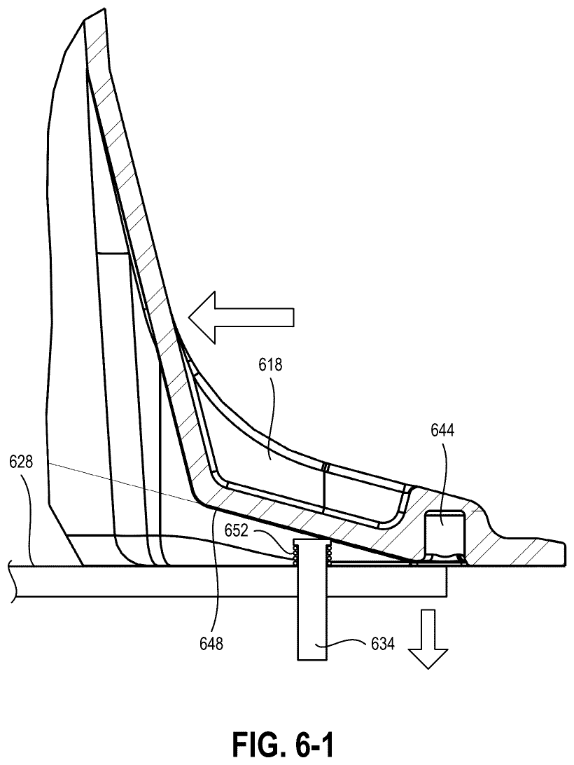

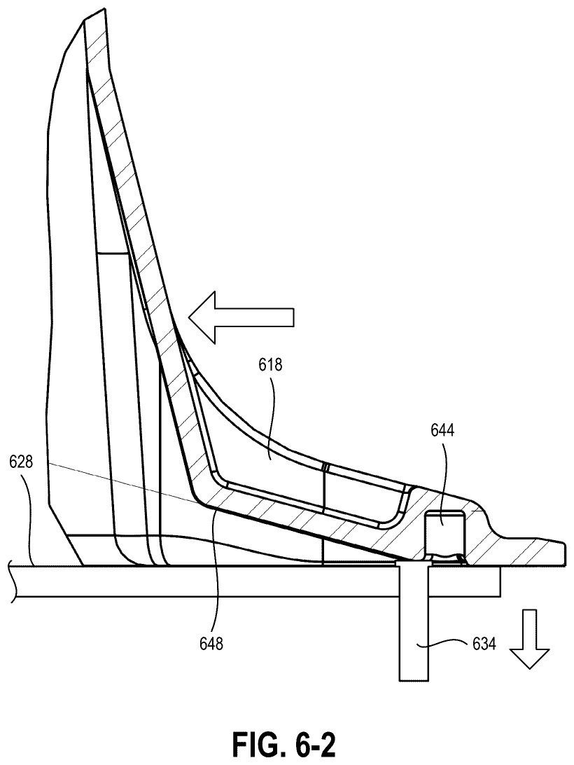

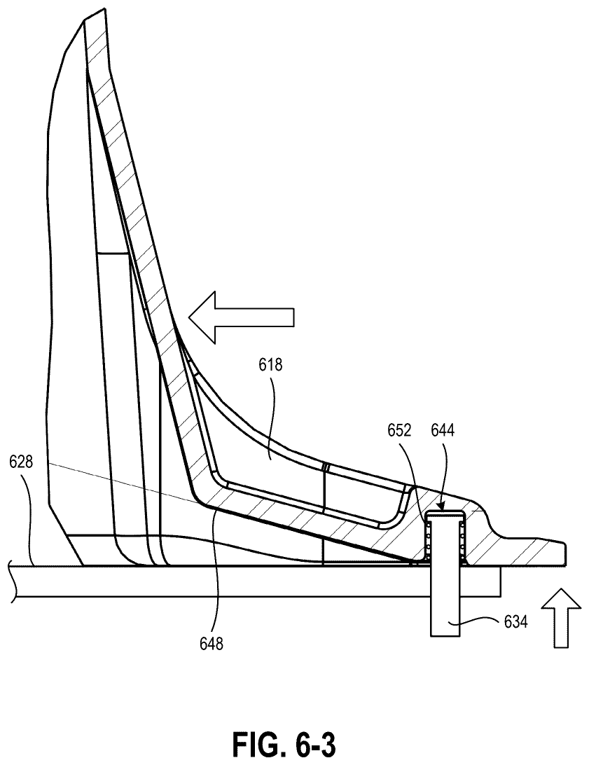

FIG. 6-1 through FIG. 6-3 illustrate the insertion and locking process of assembling the mounting device, according to some embodiments of the present disclosure. As the mount body 618 translates relative to the base surface 628, the ramp surface 648 interacts with the locking pin 634 to urge the locking pin 634 downward against a biasing element 652. The ramp surface 648 depresses the locking pin 634 as the pin pocket 644 approaches the locking pin 634. FIG. 6-2 illustrates the locking pin 634 approaching the pin pocket 644. In some embodiments, the locking pin 634 is fully depressed against the base surface 628 before the pin pocket 644. For example, the locking pin 634 may have a top end that is flush with the base surface 628. In some examples, a lip of the locking pin 634 may contact the base surface 628. In some embodiments, the top end and/or lip of the locking pin 634 may not be flush with and/or in contact with the base surface 628 before the locking pin 634 enters the pin pocket 644.

FIG. 6-3 illustrates the locking pin 634 entering the pin pocket 644. For example, the continued translation of the mount body 618 relative to the locking pin 634 and base surface 628 causes the locking pin 634 to align with the pin pocket 644. In some embodiments, the biasing element 652 then applies a restoring force to the locking pin 634 to extend the locking pin 634 into the pin pocket 644. The movement of the locking pin 634 in the locking direction normal to the base surface 628 into the pin pocket 644 provides a tactile confirmation, audible confirmation, visual confirmation, or combinations thereof for the operator or technician assembling the mounting device. In some embodiments, the locking pin 634 will only align with the pin pocket 644 and enter into the pin pocket 644 when the mount body 618 is inserted into the collar in the correct orientation and inserted fully into the collar. In some embodiments, the ramp surface 648 is tapered in a ramp width to further align the locking pin 634 with the pin pocket 644 and/or apply a torque to the mount body 618 to rotationally align the mount body 618 with the collar during assembly of the mounting device.

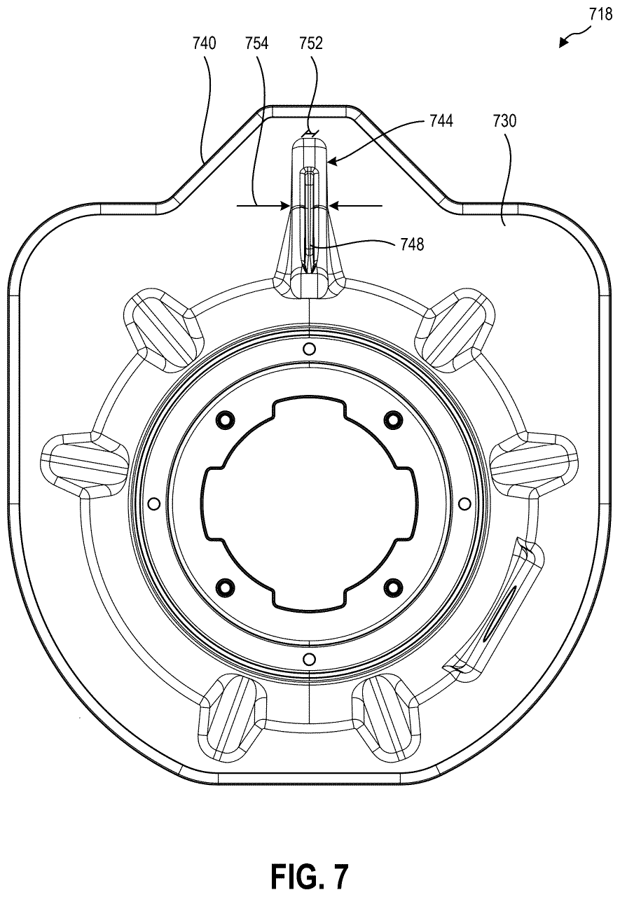

FIG. 7 is a bottom view of an embodiment of a mount body 718 illustrating a ramp surface 748 and pin pocket 744. In some embodiments, the ramp surface 748 has a ramp width 754 that decreases toward the pin pocket 744. The ramp surface 748, thereby, tapers toward the pin pocket 744 and/or toward the trailing edge 740 of the flange 730. In some embodiments, the decreasing ramp width 754 toward the pin pocket 744 applies a torque to the mount body 718 when the locking pin interacts with the ramp surface 748 during insertion of the mount body 718 in the collar.

In some embodiments, the pin pocket 744 has a pocket diameter 752 that is no more than 10% greater than a pin diameter of the locking pin. In some embodiments, the pin pocket 744 has a pocket diameter 752 that is no more than 20% greater than a pin diameter of the locking pin. In some embodiments, the pin pocket 744 has a pocket diameter 752 that is no more than 25% greater than a pin diameter of the locking pin.

In some embodiments, the ramp width 754 proximate to the pin pocket 744 is no more than 10% greater than a pin diameter of the locking pin. In some embodiments, the ramp width 754 is no more than 25% greater than a pin diameter of the locking pin. In some embodiments, the ramp width 754 is no more than 50% greater than a pin diameter of the locking pin.

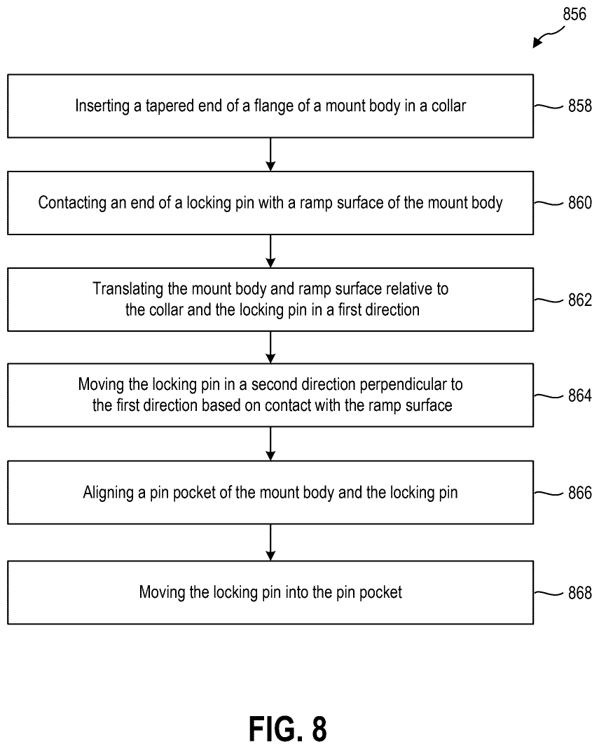

FIG. 8 is a flowchart illustrating a method 856 of use of a mounting device, according to some embodiments of the present disclosure. In some embodiments, the method 856 includes inserting a tapered end of a flange of a mount body in a collar at 858. For example, the mount body may have a flange with a tapered leading edge, such as described at least in relation to FIG. 4. In some embodiments, the tapered leading edge has a linear leading edge (e.g., perpendicular to an insertion direction of the flange) that is narrower than a maximum width of the flange. In some embodiments, the tapered leading edge tapers to a rounded or continuously curved leading edge. In some embodiments, the tapered leading edge tapers to a pointed or discontinuous leading edge.

The method 856 further includes contacting an end of a locking pin with a ramp surface of the mount body at 860. For example, the ramp surface may be oriented downward relative to the mount body such that the ramp surface is oriented in the direction of the first plane of the flange of the mount body. In some embodiments, at least a portion of the ramp surface is oriented at an angle to the first plane. In some embodiments, the ramp surface is substantially linear. In some embodiments, the ramp surface is curved. In some embodiments, at least a portion of the ramp surface is linear and at least a portion of the ramp surface is curved. At least a portion of the ramp surface is oriented at a ramp angle in a range having an upper value, a lower value, or upper and lower values including any of 1°, 5°, 10°, 15°, 20°, 25°, 30°, or any values therebetween. In some examples, the at least a portion of the ramp surface is at a ramp angle greater than 1°. In some examples, the at least a portion of the ramp surface is at a ramp angle less than 30°. In some examples, the at least a portion of the ramp surface is at a ramp angle between 1° and 30°. In some examples, the at least a portion of the ramp surface is at a ramp angle between 5° and 20°.

In some embodiments, the method 856 further includes translating the mount body and ramp surface relative to the collar and the locking pin in a first direction at 862. For example, the flange may contact a base surface of the collar (or to which the collar is coupled), and the mount body may be moved in an insertion direction in the plane of the base surface. In some embodiments, the mount body is positioned on the base surface with a first plane of the flange and a second plane defined by the base surface oriented parallel to one another. In at least one example, the flange will not enter the collar fully without the flange parallel to the collar.

The method 856, in some embodiments, includes moving the locking pin in a second direction perpendicular to the first direction based on contact with the ramp surface at 864. The ramp surface contacting a top end of the locking pin is arranged and configured to convert at least a portion of the movement of the mount body in the insertion direction to a perpendicular force on the locking pin. The perpendicular force moves the locking pin in the second direction (e.g., locking direction) perpendicular to the insertion direction. In some embodiments, the locking direction is perpendicular to the first plane. In some embodiments, the locking direction is perpendicular to the second plane. In some embodiments, the locking direction is oriented at a non-perpendicular angle to the second plane, with at least a component of the motion oriented at a perpendicular angle to the second plane. In some embodiments, the locking direction is an arcuate path with a component of the path oriented at a perpendicular angle to the second plane.

As described herein, in some embodiments, the mount body and the flange fully enter and lock in the collar only when the flange is complementarily aligned with the collar. For example, the collar and the flange may be asymmetric front-to-back and/or left-to-right, but complementarily shaped to allow mating of the collar and flange. As described herein, in some embodiments, the geometry of the pin pocket, the ramp surface, the flange, and/or the locking pin operate together to apply a torque to the mount body relative to the collar to rotationally align the mount body and the collar during insertion. In some embodiments, the method 856 further includes aligning a pin pocket of the mount body and the locking pin at 866 and moving the locking pin into the pin pocket at 868.

In some embodiments, the ramp surface has a ramp width that tapers toward the pin pocket, such that the locking pin and the ramp surface interact during insertion to apply a torque to the mount body relative to the collar to rotationally align the mount body and the collar. In some embodiments, the leading edge of the flange interacts with the collar to apply a torque to the mount body relative to the collar to rotationally align the mount body and the collar. Upon sufficient insertion and alignment of the flange relative to the collar, the locking pin aligns with the pin pocket and, in some embodiments, a biasing element urges the locking pin at least partway into the pin pocket. For example, the biasing element may be or include a spring, a bushing, a magnet, or other mechanism that produces a restoring force on the locking pin that opposes a displacement of the locking pin by the ramp surface away from an original position.

When the locking pin enters the pin pocket, the mounting device provides to an operator or technician assembling the mounting device a visual confirmation, a tactile confirmation, an audible confirmation, or combinations thereof to inform the operator that the mount body (and any electronic component mounted thereto) is coupled to the collar at a known position and orientation. For example, the mount body (and any electronic component mounted thereto) is coupled to the head unit at a known position and orientation for the accurate and precise control of directional electronic components. The locking pin further retains the mount body relative to the collar to ensure the mount body (and any electronic component mounted thereto) will not move relative to the head unit. In some embodiments, the operator or technician assembling the mounting device is therefore able to assemble and deploy a unit (such as described in relation to FIG. 1) quickly and confidently. The operator may further assemble and deploy the unit in a variety of adverse conditions or other situations in which the operator has limited ability to see the head unit and/or handle the components precisely (e.g., darkness, precipitation, cold, wind). Mounting devices according to at least some embodiments of the present disclosure can reduce time, costs, and resources needed to quickly and reliably deploy units in the field.

The present disclosure relates to mounting devices, systems, and methods according to at least the following clauses:
Clause 1. A mounting device comprising: a mount body including: a flange protruding radially outward in a first plane, and a pin pocket recessed into the mount body normal to the first plane; a base surface; and a collar coupled to the base surface including: a slot arranged in a second plane and configured to receive the flange, and a locking pin movable in a locking direction normal to the second plane and configured to insert into the pin pocket.
Clause 2. The mounting device of clause 1, further comprising a ramp surface of the mount body oriented toward the first plane, wherein the ramp surface ends at the pin pocket.
Clause 3. The mounting device of clause 2, wherein at least a portion of the ramp surface has a ramp angle between 1° and 30°.
Clause 4. The mounting device of clause 2, wherein the ramp surface is substantially linear with respect to a ramp angle relative to the first plane.
Clause 5. The mounting device of clause 2, wherein the ramp surface has a ramp width no more than 50% greater than a pin diameter of the locking pin proximate to the pin pocket.
Clause 6. The mounting device of clause 2, wherein the ramp surface has a ramp width that tapers toward the pin pocket.
Clause 7. The mounting device of clause 1, further comprising a biasing element connected to the locking pin, wherein the biasing element applies a force to the locking pin in the locking direction.
Clause 8. The mounting device of clause 1, wherein the flange includes a tapered leading edge that is narrower than a trailing edge of the flange.
Clause 9. The mounting device of clause 1, wherein the pin pocket has a pocket diameter no more than 25% greater than a pin diameter of the locking pin.
Clause 10. The mounting device of clause 1, wherein the mount body has a lateral port.
Clause 11. The mounting device of clause 1, wherein the mount body has a mount surface opposite the flange.
Clause 12. The mounting device of clause 1, wherein the flange has constant thickness.
Clause 13. A system for mounting an electronic component, the system comprising: a frame configured to support at least one electronic component; a mast connection coupled to a bottom side of the frame; and a mounting device coupled to a top side of the frame, the mounting device including: a mount body including: a flange protruding radially outward in a first plane, and a pin pocket recessed into the mount body normal to the first plane, a base surface coupled to the frame, and a collar coupled to the base surface including: a slot arranged in a second plane and configured to receive the flange; and a locking pin movable in a locking direction normal to the second plane and configured to insert into the pin pocket.
Clause 14. The system of clause 13, further comprising at least one electronic component coupled to a mount surface of the mount body opposite the flange.
Clause 15. The system of clause 14, wherein the at least one electronic component is a spotlight.
Clause 16. The system of clause 14, wherein the at least one electronic component is a camera.
Clause 17. The system of clause 14, further comprising a lateral port in the mount body and an electrical cable positioned through the lateral port and providing communication between the at least one electronic component and a computing device supported by the frame.
Clause 18. A method of mounting an electronic component on a frame, the method comprising: inserting a tapered end of a flange of a mount body in a collar; contacting an end of a locking pin with a ramp surface of the mount body; translating the mount body and ramp surface relative to the collar and the locking pin in a first direction; moving the locking pin in a second direction perpendicular to the first direction based on contact with the ramp surface; aligning a pin pocket of the mount body and the locking pin; and moving the locking pin into the pin pocket.
Clause 19. The method of clause 18, wherein aligning a pin pocket and the locking pin includes moving the ramp surface relative to the locking pin wherein the ramp surface tapers in a ramp width toward the pin pocket.
Clause 20. The method of clause 18, wherein moving the locking pin into the pin pocket includes a biasing element applying a restoring force to the locking pin.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method. In addition, in the accompanying figures, and unless otherwise described, similar elements are denoted by the same numerical designation, with the exception of the first digit. For example, element 1XX in one figure corresponds to element 2XX in another figure, highlighting their functional similarity. As a specific example, the head unit 206 described with reference to FIG. 2 may be the same as the head unit 306 described with reference to FIG. 3.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A mounting device for a mobile security unit, the mounting device comprising:
a mount body including:
a flange protruding radially outward in a first plane, and
a pin pocket recessed into the mount body normal to the first plane;
a base surface; and
a collar coupled to the base surface including:
a slot arranged in a second plane and configured to receive the flange, and
a locking pin movable in a locking direction normal to the second plane and configured to insert into the pin pocket.

2. The mounting device of claim 1, wherein the mount body comprises a ramp surface oriented toward the first plane, wherein the ramp surface ends at the pin pocket.

3. The mounting device of claim 2, wherein at least a portion of the ramp surface has a ramp angle between 1° and 30°.

4. The mounting device of claim 2, wherein the ramp surface is substantially linear with respect to a ramp angle relative to the first plane.

5. The mounting device of claim 2, wherein the ramp surface has a ramp width no more than 50% greater than a pin diameter of the locking pin proximate to the pin pocket.

6. The mounting device of claim 2, wherein the ramp surface has a ramp width that tapers toward the pin pocket.

7. The mounting device of claim 1, further comprising a biasing element connected to the locking pin, wherein the biasing element applies a force to the locking pin in the locking direction.

8. The mounting device of claim 1, wherein the flange includes a tapered leading edge that is narrower than a trailing edge of the flange.

9. The mounting device of claim 1, wherein the pin pocket has a pocket diameter no more than 25% greater than a pin diameter of the locking pin.

10. The mounting device of claim 1, wherein the mount body has a lateral port.

11. The mounting device of claim 1, wherein the mount body has a mount surface opposite the flange.

12. The mounting device of claim 1, wherein the flange has a constant thickness.

13. A system for mounting an electronic component of a mobile security unit, the system comprising:
a frame configured to support at least one electronic component;
a mast connection coupled to a bottom side of the frame; and
a mounting device coupled to a top side of the frame, the mounting device including:
a mount body including:
a flange protruding radially outward in a first plane, and
a pin pocket recessed into the mount body normal to the first plane,
a base surface coupled to the frame, and
a collar coupled to the base surface including:
a slot arranged in a second plane and configured to receive the flange; and
a locking pin movable in a locking direction normal to the second plane and configured to insert into the pin pocket.

14. The system of claim 13, further comprising at least one electronic component coupled to a mount surface of the mount body opposite the flange.

15. The system of claim 14, wherein the at least one electronic component is a spotlight.

16. The system of claim 14, wherein the at least one electronic component is a camera.

17. The system of claim 14, further comprising a lateral port in the mount body and an electrical cable positioned through the lateral port and providing communication between the at least one electronic component and a computing device supported by the frame.

18. A method of mounting an electronic component of a mobile security unit on a frame, the method comprising:
inserting a tapered end of a flange of a mount body in a collar;
contacting an end of a locking pin with a ramp surface of the mount body;
translating the mount body and ramp surface relative to the collar and the locking pin in a first direction;
moving the locking pin in a second direction perpendicular to the first direction based on contact with the ramp surface;
aligning a pin pocket of the mount body and the locking pin; and
moving the locking pin into the pin pocket.

19. The method of claim 18, wherein aligning a pin pocket and the locking pin includes moving the ramp surface relative to the locking pin wherein the ramp surface tapers in a ramp width toward the pin pocket.

20. The method of claim 18, wherein moving the locking pin into the pin pocket includes a biasing element applying a restoring force to the locking pin.
